(19) United States
(12) Patent Application Publication
(10) Pub. No.: US 2018/0354823 A1
(43) Pub. Date: Dec. 13, 2018

(54) APPARATUS FOR REDUCING HARMFUL SUBSTANCE IN SEWAGE AND WASTE WATER FOR ECOTOXICITY REMOVAL AND SYSTEM COMPRISING THE SAME

(71) Applicant: GROON CO., LTD., Jeollabuk-do (KR)

(72) Inventors: In Ho Lee, Jeollabuk-do (KR); Young Pyo Hong, Jeollabuk-do (KR)

(21) Appl. No.: 15/923,947

(22) Filed: Mar. 16, 2018

(30) Foreign Application Priority Data
Jun. 9, 2017 (KR) 10-2017-0072481

(51) Int. Cl. C02F 1/48; C02F 1/74; C02F 7/00; C02F 9/00

(52) U.S. Cl. CPC C02F 1/487; C02F 1/74; C02F 2103/007; C02F 9/00; C02F 7/00

(57) ABSTRACT

The present disclosure relates to an apparatus for reducing harmful substance in sewage and waste water for ecotoxicity removal, including a main decomposition unit in which sewage and waste water is treated and an activated electron aeration device for decomposing the sewage and waste water.

### CROSS-REFERENCE TO RELATED APPLICATION

This application claims priority of Korean Patent Application No. 10-2017-0072481, filed on Jun. 9, 2017, in the KIPO (Korean Intellectual Property Office), the disclosure of which is incorporated herein entirely by reference.

### BACKGROUND OF THE INVENTION

### Field of the Invention

The present disclosure relates to an apparatus and system for reducing harmful substance in sewage and waste water for ecotoxicity removal, and more particularly, to an apparatus and system for reducing harmful substance in sewage and waste water to provide dissolved oxygen-rich healthy water with increased treatment efficiency of sewage and waste water.

### Description of the Related Art

Among currently available disinfection methods, in the case of chlorine disinfection, there is a trend toward stopping disinfection facility due to the health risks of trihalomethane (THM), disinfection by-products, and impacts on water plants. In fact, experimental results reveal that sewage treatment by chlorine affects acute or chronic toxicity in water plants and reduces the type and number of fish. The domestic nation has a problem with a disinfection selecting method due to installation areas and a lack of skills and know-how of disinfection methods other than chlorine disinfection.

Recently, an ultraviolet (UV) disinfection apparatus is developed and being used in reality. As the health risk issue of chlorine disinfection is raised, developed nations tend to gradually change to UV disinfection starting from regions in urgent need for environmental ecosystem protection such as closed water area or aquatic organisms, but in the case of UV disinfection, a disadvantage is a high maintenance and management cost. In addition, UV disinfection as described above inactivates microorganisms by photo-oxidation effects on DNA, and the damaged DNA in microorganisms is recovered and activated by light recovery effects when exposed to light, so there is reluctance in adoption of a UV disinfection method. The damaged DNA can be recovered by fluorescent light or solar light.

Additionally, recently, besides UV disinfection, the use of ozone is gradually increasing in the field of water treatment, but in the case of ozone, it is effective in killing organics or microorganisms but its disadvantage is high initial investment and maintenance costs.

Accordingly, development of technology for eco-friendly treatment of sewage including harmful pollutants without using toxic and chemical substances is in urgent need.

### SUMMARY OF THE INVENTION

The present disclosure is directed to providing an apparatus for reducing harmful substance in sewage and waste water for ecotoxicity removal in an eco-friendly manner without using toxic and chemical substances.

To achieve the object, the present disclosure provides an apparatus for reducing harmful substance in sewage and waste water for ecotoxicity removal, including a main decomposition unit in which sewage and waste water is treated, wherein the main decomposition unit includes: a decomposition tank; a main electron generation device provided outside of the decomposition tank to generate electron; a main electron injection line which moves the electron from the main electron generation device into the decomposition tank; a wave generation device provided in the decomposition tank to activate the electron generated from the main electron generation device by applying an electric field to the electron; and multiple plates provided on an inner wall of the decomposition tank and the main electron injection line, spaced apart from each other, the main electron generation device includes: a discharge pin module provided with a support plate, multiple discharge pins coupled to the support plate, and an elastic connection element electrically connecting a group of discharge pins including at least two adjacent discharge pins of the multiple discharge pins and coupled to the support plate; a discharge plate placed facing the multiple discharge pins; a support structure provided with a coupling plate positioned on an opposite side to the discharge plate with the support plate interposed between, the discharge pin module and the discharge plate being detachably coupled to the coupling plate; and a circuit module provided with a main board positioned apart from the coupling plate on an opposite side to the discharge pin module with the coupling plate interposed between, and multiple distributed processing boards connected to the main board to enable individual application of high voltage, high frequency pulsed power to the group of discharge pins, the coupling plate has multiple connection protrusions each electrically connected to the multiple distributed processing boards, and an end of the elastic connection element comes into contact with the connection protrusion.

The sewage and waste water may be supplied from an oxidation tank installed at a front end of the main decomposition unit.

The apparatus for reducing harmful substance in sewage and waste water may further include an activated electron aeration device on a lower surface of the decomposition tank, wherein the activated electron and radical generated from the main electron generation device is aerated by the activated electron aeration device to decompose the sewage and waste water in the decomposition tank.

The activated electron and radical generated from the main electron generation device may be activated by the wave generation device while passing by the multiple plates obliquely extending spaced apart from each other from the lower surface of the decomposition tank, and the sewage and waste water may be decomposed and discharged to the oxidation tank.

According to the present disclosure, there is provided a system for reducing harmful substance in sewage and waste water for ecotoxicity removal including the above-described apparatus for reducing harmful substance in sewage and waste water.

The sewage and waste water treatment apparatus according to the present disclosure removes pollutants in sewage and waste water using eco-friendly OH radicals without using chemicals including toxicity, and increases the treatment efficiency of sewage and waste water using multiple plates spaced apart from each other in the decomposition tank, thereby providing dissolved oxygen-rich healthy water.

Additionally, according to the present disclosure, there is provided an electron generation device including: a discharge pin module provided with a support plate, multiple discharge pins coupled to the support plate, and an elastic connection element electrically connecting a group of discharge pins including at least two adjacent discharge pins of the multiple discharge pins and coupled to the support plate; a discharge plate placed facing the multiple discharge pins; a support structure provided with a coupling plate positioned on an opposite side to the discharge plate with the support plate interposed between, the discharge pin module and the discharge plate being detachably coupled to the coupling plate; and a circuit module provided with a main board positioned apart from the coupling plate on an opposite side to the discharge pin module with the coupling plate interposed between, and multiple distributed processing boards connected to the main board to enable individual application of high voltage, high frequency pulsed power to the group of discharge pins, wherein the coupling plate has multiple connection protrusions each electrically connected to the multiple distributed processing boards, and an end of the elastic connection element comes into contact with the connection protrusion, and assembly and disassembly of the circuit module, the discharge pin module and the discharge plate is easy and thus workability is improved.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a cross-sectional view showing the structure of an apparatus according to an embodiment of the present disclosure.

FIG. 2 is a cross-sectional view showing the structure of an apparatus according to another embodiment of the present disclosure.

FIG. 3 is a cross-sectional view showing the structure of a main decomposition unit according to an embodiment of the present disclosure.

FIG. 4 shows the structure of a wave generation device according to an embodiment of the present disclosure.

FIG. 5 is a cross-sectional view showing another protrusion according to another embodiment of the present disclosure.

FIG. 6 shows the principle of sewage and waste water treatment according to the present disclosure.

FIG. 7 shows a pollutant treatment process through an oxidation process according to the present disclosure.

FIG. 8 shows E. coli sterilization evaluation results of an apparatus according to an embodiment of the present disclosure.

FIG. 9 shows S. aureus sterilization evaluation results of an apparatus according to an embodiment of the present disclosure.

FIG. 10 is a side view of a main electron generation device shown in FIG. 3, in which internal parts are visible.

FIG. 11 is an enlarged view of an electron generation unit shown in FIG. 10.

FIG. 12 is an enlarged view of section ‘A’ of FIG. 11.

FIG. 13 is an exploded perspective view showing main components of FIG. 11.

FIG. 14 is a partially enlarged view of upper surface of a discharge pin plate shown in FIG. 13.

FIG. 15 is partially enlarged view of lower surface of a discharge pin plate shown in FIG. 13.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

The present disclosure provides an apparatus for reducing harmful substance in sewage and waste water for ecotoxicity removal including a main decomposition unit 2a in which sewage and waste water is treated, wherein the main decomposition unit 2a includes a decomposition tank 2, a main electron generation device 21a provided outside of the decomposition tank 2 to generate electrons, a main electron injection line 22a that moves the electrons from the main electron generation device 21a into the decomposition tank 2, wave generation devices 24, 25 provided in the decomposition tank 2 to activate the electrons generated from the main electron generation device 21a by applying an electric field to the electrons, and multiple plates 26, 27, 28, 29, 30, 31 provided on the inner walls of the decomposition tank and the main electron injection line 22a, spaced apart from each other.

The apparatus for reducing harmful substance in sewage and waste water is supplied with the sewage and waste water from an oxidation tank 1 installed at the front end of the main decomposition unit 2a.

Additionally, the present disclosure provides an apparatus for reducing harmful substance in sewage and waste water for ecotoxicity removal including an oxidation tank 1 that may be installed at the front or rear end of an existing treatment plant, a main decomposition unit 2a in which sewage and waste water supplied from the oxidation tank 1 is treated, and an auxiliary decomposition unit 2b that performs primary decomposition of sewage and waste water before supplying the sewage and waste water to the main decomposition unit 2a, wherein the auxiliary decomposition unit 2b includes a sewage/waste water supply line 11 that supplies sewage and waste water from the oxidation tank 1 to the main decomposition unit 2a, an auxiliary electron generation device 21b provided outside of the oxidation tank 1 to generate electrons and radicals, and an auxiliary electron injection line 22b that supplies the electrons and radicals from the auxiliary electron generation device 21b to the sewage/waste water supply line 11.

The auxiliary decomposition unit 2b further includes multiple protrusions 33, 34 provided on the inner walls of the sewage/waste water supply line, and the protrusions 33, 34 are installed on the inner walls of the sewage/waste water supply line 11 with a structure to reduce the movement speed of sewage and waste water, thereby increasing the time during which sewage and waste water stays in the sewage/waste water supply line 11.

The main decomposition unit 2a includes a decomposition tank 2, a main electron generation device 21a provided outside of the decomposition tank 2 to generate electrons, a main electron injection line 22a that moves the electrons from the main electron generation device 21a into the decomposition tank 2, and wave generation devices 24, 25 provided in the decomposition tank 2 to activate the electrons and radicals generated from the main electron generation device 21a by applying an electric field to the electrons and radicals, and may further include multiple plates 26, 27, 28, 29, 30, 31 provided on the inner walls of the decomposition tank 2 and the main electron injection line 21a, spaced apart from each other.

The apparatus for reducing harmful substance in sewage and waste water may further include an activated electron aeration device 23 on the lower surface of the decomposition tank 2, and the activated electrons and radicals generated from the main electron generation device 21a and/or the auxiliary electron generation device 21b are aerated by the activated electron aeration device 23 to decompose the sewage and waste water in the decomposition tank 2.

The apparatus for reducing harmful substance in sewage and waste water has a structure in which the activated electrons and radicals generated from the main electron generation device 21a and/or the auxiliary electron generation device 21b are activated by the wave generation devices 24, 25 while passing by the multiple plates 26, 27, 28, 29, 30, 31 obliquely extending spaced apart from each other from the lower surface of the decomposition tank 2, and the sewage and waste water is decomposed and discharged to the oxidation tank 1.

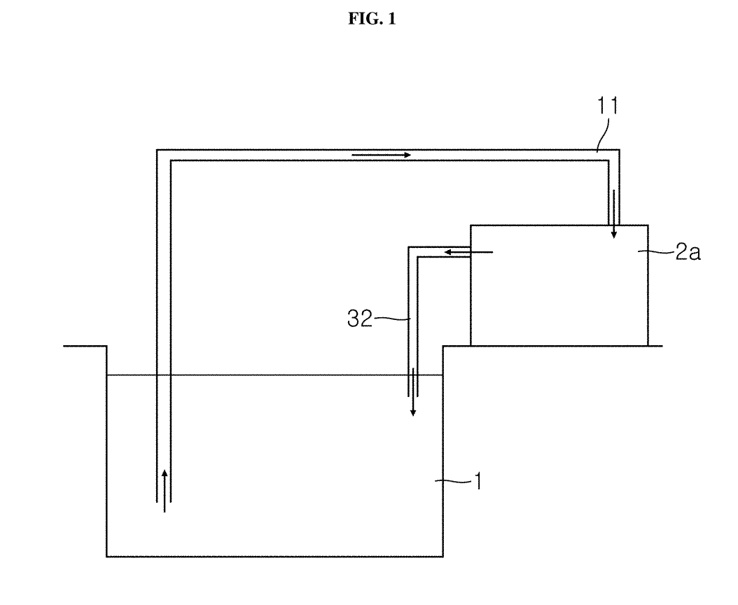

FIG. 1 shows the structure of an apparatus for reducing harmful substance in sewage and waste water according to an embodiment of the present disclosure. Referring to FIG. 1, the apparatus for reducing harmful substance in sewage and waste water according to an embodiment of the present disclosure includes an oxidation tank 1 installed at the front or rear end of an existing treatment plant to remove soluble organics by aerobic microorganisms and oxidize a portion of ammonia nitrogen, a main decomposition unit 2a in which sewage and waste water supplied from the oxidation tank 1 is decomposed, a sewage/waste water supply line 11 that supplies sewage and waste water in the oxidation tank 1 to the main decomposition unit 2, and a decomposed sewage/waste water and activated electron discharge line 32 that discharges the sewage and waste water decomposed by the main decomposition unit 2a to the oxidation tank 1.

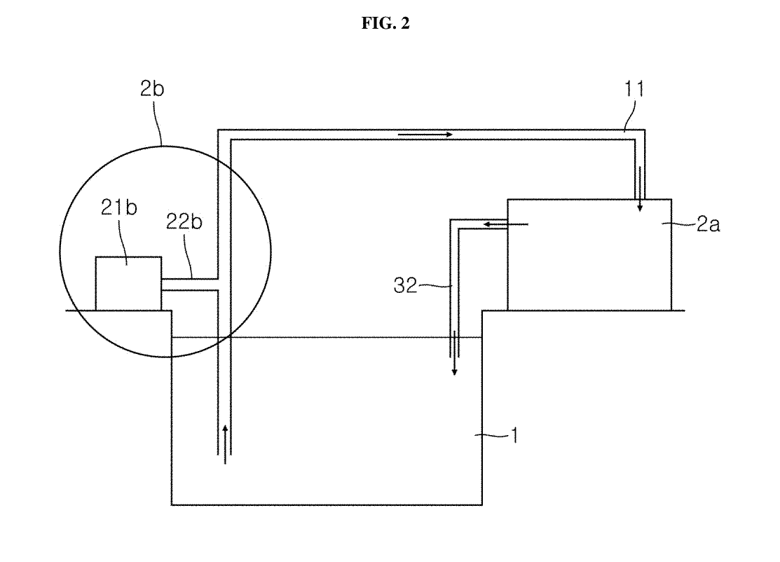

FIG. 2 shows the structure of an apparatus for reducing harmful substance in sewage and waste water according to another embodiment of the present disclosure. Referring to FIG. 2, the apparatus for reducing harmful substance in sewage and waste water according to another embodiment of the present disclosure includes an oxidation tank 1 installed at the front or rear end of an existing treatment plant to remove soluble organics by aerobic microorganisms and oxidize a portion of ammonia nitrogen, a main decomposition unit 2a in which sewage and waste water supplied from the oxidation tank 1 is treated, and an auxiliary decomposition unit 2b that performs primary decomposition of sewage and waste water before supplying the sewage and waste water to the main decomposition unit 2a, and the auxiliary decomposition unit 2b includes a sewage/waste water supply line 11 that supplies sewage and waste water from the oxidation tank 1 to the main decomposition unit 2a, an auxiliary electron generation device 21b provided outside of the oxidation tank to generate electrons and radicals, and an auxiliary electron injection line 22b that supplies the electrons and radicals from the auxiliary electron generation device 21b to the sewage/waste water supply line 11.

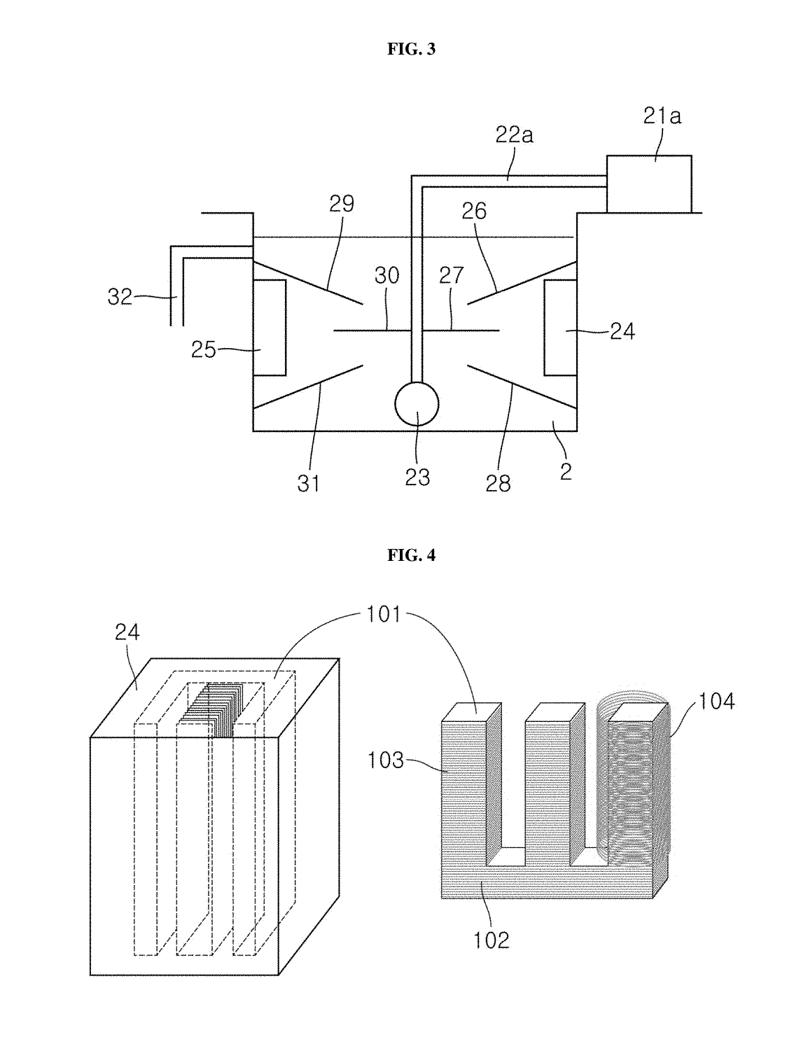

FIG. 3 shows an embodiment of the main decomposition unit 2a shown in FIGS. 1 and 2. Referring to FIG. 3, the main decomposition unit (2a in FIGS. 1 and 2) according to an embodiment of the present disclosure includes a decomposition tank 2 in which sewage and waste water supplied from the oxidation tank (1 in FIGS. 1 and 2) through the sewage/waste water supply line (11 in FIGS. 1 and 2) is stored, a main electron generation device 21a positioned outside of the decomposition tank 2 to generate electrons, a main electron injection line 22a extending along a vertical direction in the decomposition tank 2 to inject the electrons and radicals generated from the main electron generation device 21a into the decomposition tank 2, an activated electron aeration device 23 connected the lower end of the main electron injection line 22a and positioned adjacent to the bottom of the decomposition tank 2 to discharge the electrons in the activated decomposition tank 2, wave generation device devices 24, 25 positioned in the decomposition tank 2 to activate the electrons by applying an electric field to the electrons and radicals moving along the main electron injection line 22a and the electrons and radicals in the decomposition tank 2, and multiple plates 26, 27, 28, 29, 30, 31 obliquely installed on the inner walls of the decomposition tank 2 and the outer walls of the main electron injection line 22a, spaced apart from each other within the decomposition tank 2. The decomposed sewage/waste water and the activated electrons in the decomposition tank 2 are discharged to the oxidation tank (1 in FIGS. 1 and 2) through the decomposed sewage/waste water and activated electron discharge line 32.

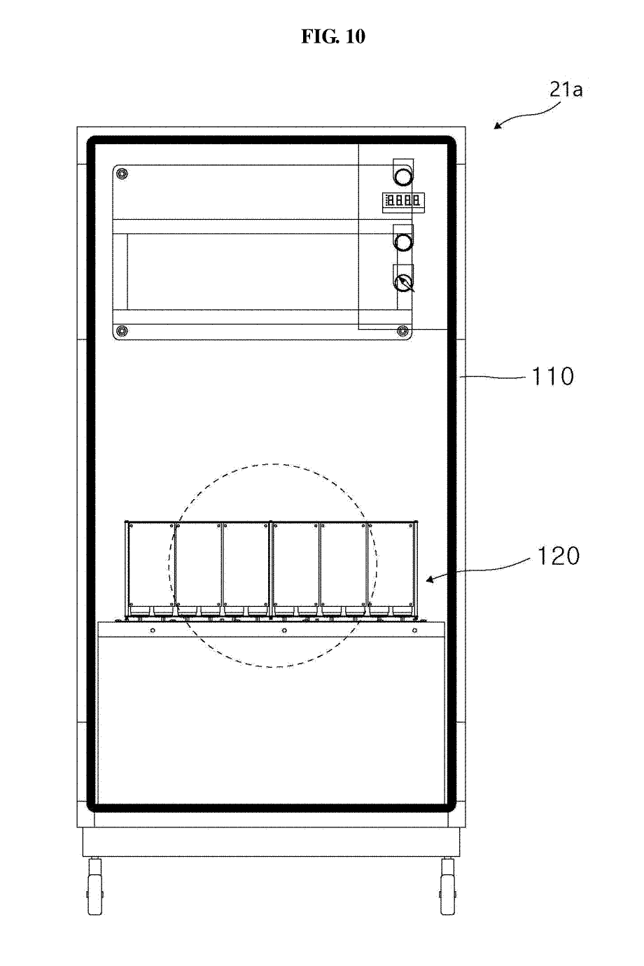

FIG. 10 is a side view of an embodiment of the main electron generation device 21a, in which internal parts are visible. Referring to FIG. 10, the electron generation device 21a includes an external case 110 and an electron generation unit 120 received in the external case 110. A control unit that controls the electron generation unit 120 and a power source unit that supplies a power source are positioned above the electron generation unit 120 and received in the external case 110 together.

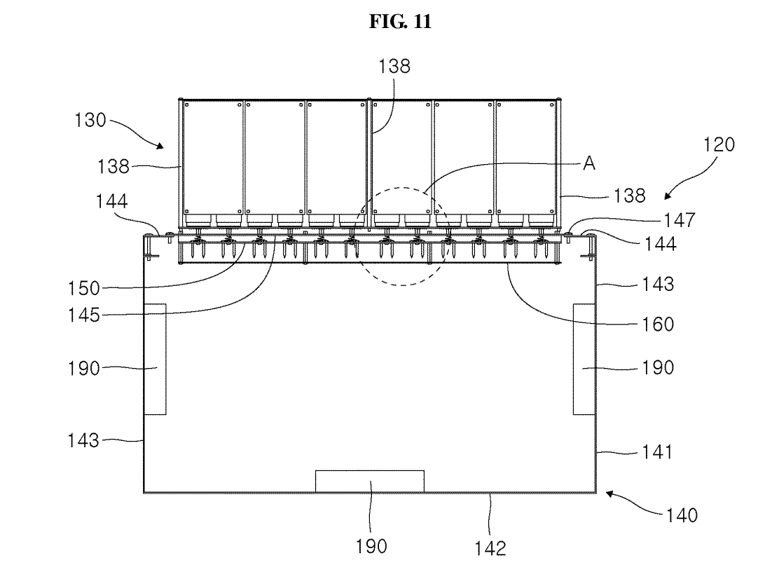

FIG. 11 shows the electron generation unit 120 of FIG. 10. Referring to FIG. 11, the electron generation unit 120 includes a circuit module 130, a support structure 140, a discharge pin module 150, a discharge plate 160, and multiple electromagnetic field generators 190.

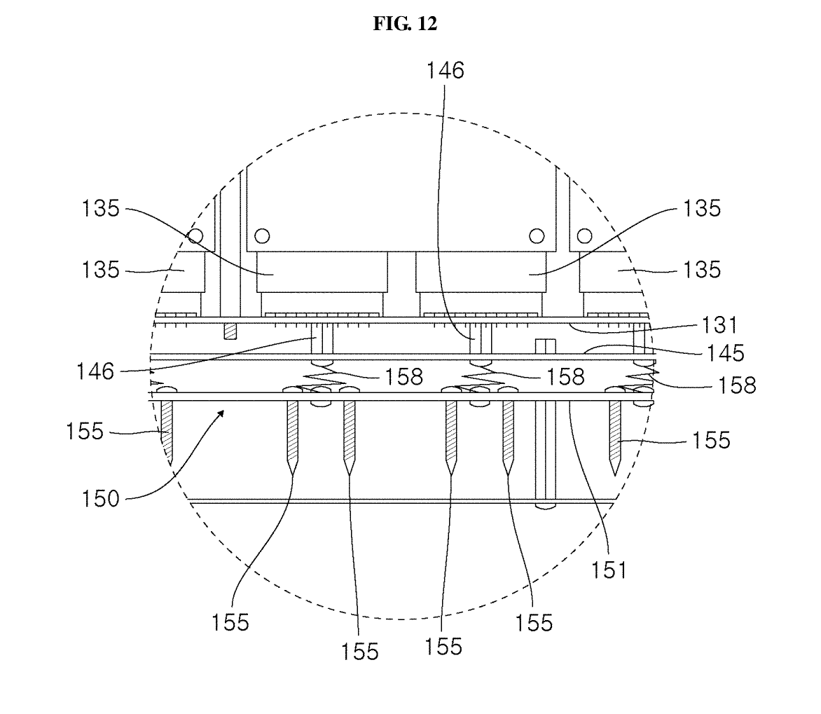

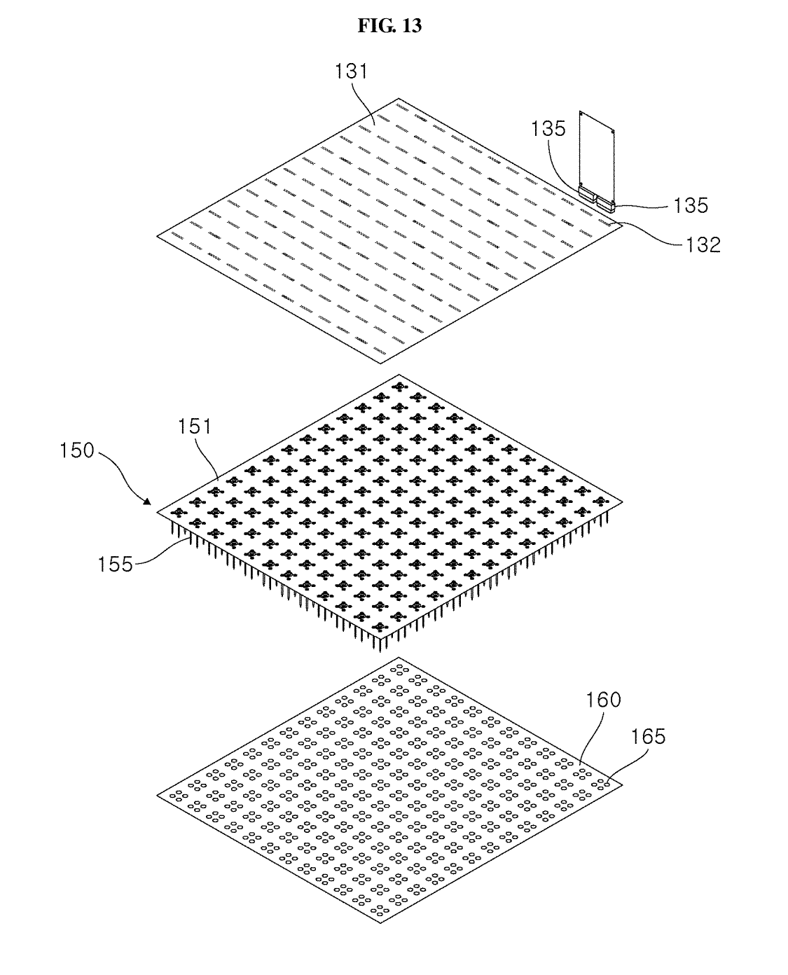

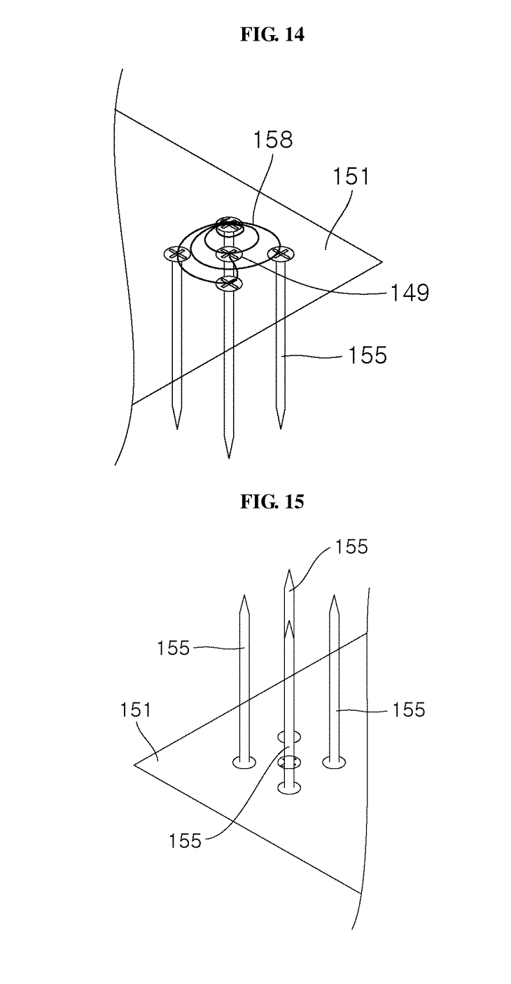

Referring to FIGS. 10 to 13, the circuit module 130 includes a main board 131, and multiple distributed processing boards 135 connected to the main board 131.

The main board 131 is in the shape of a generally flat plate, and has multiple connection parts 132 to which the multiple distributed processing boards 135 are connected. The multiple connection parts 132 are spaced apart from each other along the horizontal and vertical directions on the main board 131. The distributed processing boards 135 are positioned on one surface (an upper surface in the drawing) of the main board 131.

Each of the multiple distributed processing boards 135 has a stand-alone high voltage, high frequency pulse transformer circuit to enable individual application of high voltage, high frequency pulsed power. The multiple distributed processing boards 135 are each connected to the connection parts 132 provided in the main board 131 on one surface (an upper surface in the drawing) of the main board 131.

The main board 131 and the multiple distributed processing boards 135 connected to the main board 131 maintain tight coupling by a coupling means 138 to form the integrated circuit module 130. The circuit module 130 is detachably coupled to the support structure 140.

The support structure 140 includes a body 141, and a coupling plate 145 detachably coupled from the body 141. The body 141 includes a bottom plate 142, a sidewall part 143 extending from the bottom plate 142, and a flange part 144 extending inward from the top of the sidewall part 143. The body 141 has an empty space inside, and an inner area of the flange part 144 is open. Multiple electromagnetic field generators 190 are installed on the bottom plate 142 and the sidewall part 143 in the internal space of the body 141. In the internal space of the body 141, electrons move downward by the multiple electromagnetic field generators 190. The coupling plate 145 is detachably coupled to the flange part 144 with a coupling means 147 such as a screw, covering the open top of the body 141. The circuit module 130, the discharge pin module 150 and the discharge plate 160 are detachably coupled to the coupling plate 145. The circuit module 130 is positioned outside of the support structure 140 with the coupling plate 145 interposed between, and the discharge pin module 150 and the discharge plate 160 are positioned in the internal space of the body 141. The coupling plate 145 is made of an electrical insulating material, and has multiple connection protrusions 146 corresponding to the distributed processing boards 135 one-to-one. The connection protrusions 146 protrude from the coupling plate 145 toward the corresponding distributed processing boards 135, and are made of an electrical conducting material. The connection protrusions 146 are also exposed to the opposite surface facing the discharge pin module 150. Electricity is applied to the discharge pin module 150 by the corresponding distributed processing boards 135 through the connection protrusions 146.

The discharge pin module 150 includes a support plate 151, multiple discharge pins 155 coupled to the support plate 151, and multiple elastic connection elements 158.

The support plate 151 is in the shape of a generally flat plate, and is positioned at a predetermined distance apart from the coupling plate 145 on the opposite side to the main board 131 with the coupling plate 145 interposed between. The support plate 151 is made of an electrical insulating material. Multiple discharge pins 155 and multiple elastic connection elements 158 are coupled to the support plate 151.

The multiple discharge pins 155 protrude from the support plate 151 toward the opposite side to the coupling plate 145. The discharge pin 155 is made of an electrical conducting material, and this embodiment describes that the discharge pin 155 is formed of a screw fitted into the support plate 151. The discharge pin 155 or the screw has a head 156 positioned on the side facing the coupling plate 145, and a longitudinally extending body 157 that protrudes longitudinally to the opposite side. Adjacent discharge pins of the multiple discharge pins 155 form a group of discharge pins electrically connected. Although this embodiment describes that a group of discharge pins includes four discharge pins 155, the present disclosure is not limited thereto. Four discharge pins 155 forming a group of discharge pins are electrically connected to each other by the elastic connection element 158. High voltage from one distributed processing board 135 is applied to the corresponding group of discharge pins.

Each of the multiple elastic connection elements 158 is fixed to the support plate 151 by a fixing means or a fixing screw 149 on the surface of the support plate 151 facing the coupling plate 145. In this embodiment, the elastic connection element 158 is a compressed coil spring made of an electrical conducting material. One elastic connection element 158 electrically connects four discharge pins 155 that form a group of discharge pins. The ends of the multiple elastic connection elements 158 are contacted with and electrically connected to the corresponding connection protrusions 146 formed on the coupling plate 145.

The discharge plate 160 is in the shape of a generally flat plate, and is made of an electrical conducting material. The discharge plate 160 is positioned at a predetermined distance apart from the multiple discharge pins 155 in the internal space of the body 141 of the support structure 140. The discharge plate 160 is detachably coupled to the coupling plate 145 by a coupling means 170, together with the discharge pin module 150. Corona discharge takes place between the discharge pin 155 and the discharge plate 160, and ionized electrons and radicals are emitted from the discharge pin 155 serving as (−) electrode and moved to the discharge plate 160 serving as (+) electrode. The discharge plate 160 has multiple through-holes 165 each positioned at a shortest distance corresponding to the multiple discharge pins 155 one-to-one. In the event that impurities, including dust, from the discharge pins 155 are accumulated on the discharge plate 160 at the initial time of discharge, the through-holes 165 maintain a shortest discharge distance to improve the discharge efficiency.

Each of the multiple electromagnetic field generators 190 is installed on the bottom plate 142 and the sidewall part 143 of the body 141 to move the electrons and radicals emitted from the discharge pins 155 toward the bottom plate 142. Each of the multiple electromagnetic field generators 190 may include a core of stainless steel plated with zinc, and a coil wound around the core, and may have any configuration to generate an electromagnetic field.

The multiple plates 26, 27, 28, 29, 30, 31 include multiple first plates 26, 28, 29, 31 extending inward from the inner sidewalls of the decomposition tank 2, and multiple second plates 27, 30 extending outward from the main electron injection line 22a in the decomposition tank 2. The first plates 26, 28, 29, 31 are placed in upper and lower positions spaced apart from each other with the second plates 27, 30 interposed between such that parts of the first plates overlap with the second plates, and the two first plates 26, 28, 29, 31 placed in upper and lower positions are inclined at a narrower spacing toward the end. The second plates 27, 30 extend generally horizontally. As the sewage and waste water and the activated electrons and radicals pass by the multiple plates 26, 27, 28, 29, 30, 31 in a zigzag manner within the decomposition tank 2, the time during the sewage and waste water is decomposed by the activated electrons and radicals increases and treatment efficiency of harmful substance in sewage and waste water further increases.

The multiple wave generation devices 24, 25 are positioned adjacent to the inner walls of the decomposition tank 2. The multiple wave generation devices 24, 25 have the same configuration, and one wave generation device 24 is only described with reference to FIG. 4. Referring to FIG. 4, the wave generation device 24 includes a body part 101 formed by stacking multiple metal plates, and a coil part 104 surrounding the body part 101. The body part 101 is generally in the shape of letter ‘E’, and includes a base part 102 in contact with the inner wall of the decomposition tank 2, and three protruding wing parts 103 protruding outward from the side of the base part 102, spaced apart from each other. The coil part 104 is formed from a copper wire surrounding each of the three protruding wing parts 103, and an electric current is supplied from the outside through a waterproof electrical wire. Accordingly, when an electric current is applied to the coil part 104, an electric field is generated, and the electrons and radicals are activated while passing by the main electron injection line 22a or the plates 26, 27, 28, 29, 30, 31.

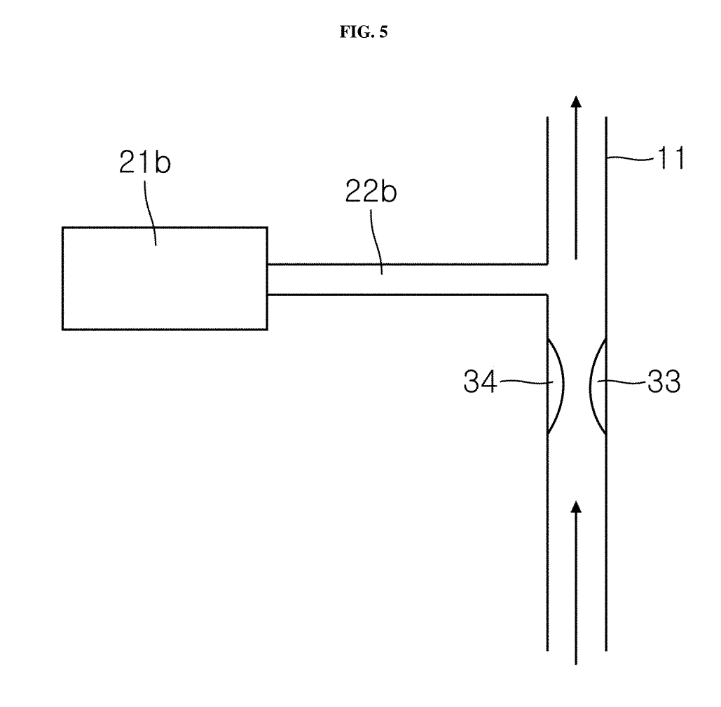

FIG. 5 shows the auxiliary decomposition unit 2b according to another embodiment of the present disclosure. Referring to FIG. 5, the auxiliary decomposition unit 2b includes the auxiliary electron generation device 21b, the auxiliary electron injection line 22b, the sewage/waste water supply line 11, and protrusions 33, 34. The auxiliary electron generation device 21b may have the same configuration as the main electron generation device 21a described previously. The electrons and radicals generated from the auxiliary electron generation device 21b may be injected into the sewage/waste water supply line 11 through the auxiliary electron injection line 22b. The multiple protrusions 33, 34 are provided in semicircular shape on the inner walls of the sewage/waste water supply line 11, and the movement speed of sewage and waste water supplied from the oxidation tank (1 in FIG. 2) to the main decomposition unit (2a in FIG. 2) is reduced by the protrusions 33, 34, thereby increasing the time during the electrons and radicals and the sewage and waste water stay in the sewage/waste water supply line 11 and increasing the decomposition efficiency of the sewage and waste water.

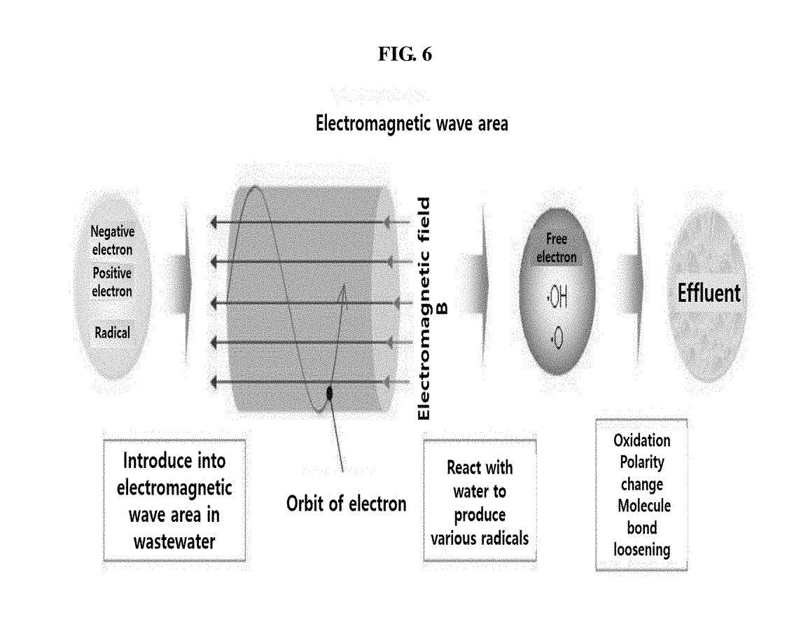

FIG. 6 shows the principle of sewage and waste water treatment according to the present disclosure, whereby electrons are generated outside by the main and/or auxiliary electron generation device 21a and/or 21b, radicals are produced by inelastic collision reactions with neutral gas in the air, the generated electrons and radicals are injected into the sewage and waste water and activated with electromagnetic waves by the wave generation devices 24, 25, and then the electrons and radicals are aerated by the activated electron aeration device 23 to oxidize organics and harmful substance in the sewage and waste water, so that the sewage and waste water may be treated.

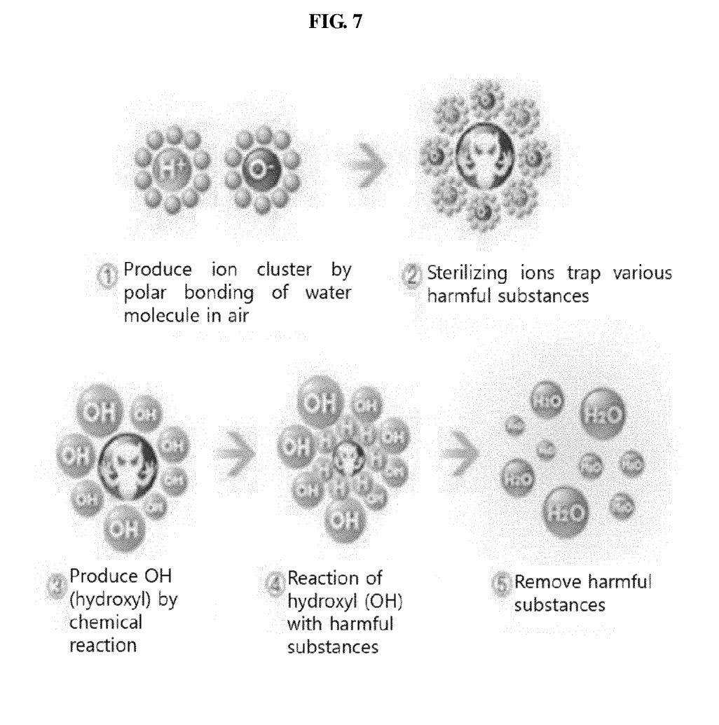

FIG. 7 shows a pollutant treatment process through an oxidation process according to the present disclosure, and ion clusters are produced by polar bonding of water molecules in the air and trap various types of harmful substance, producing OH (hydroxyl) radicals by chemical reactions, and the radicals remove the harmful substance by reactions with the harmful substance.

The OH radical is also known as ‘hydroxyl radical’, and the OH radical is a material harmless to human body that can sterilize and remove pollutants using a natural material, not a chemical substance, and has good sterilization, disinfection, deodorization and decomposition capabilities and is directly involved in pollutants in air and water to provide dissolved oxygen-rich healthy water after removing all pollutants.

Additionally, the OH radical is a strong oxidizing material. In general, oxidation refers to the process in which a substance loses electrons in a reaction with oxygen or hydrogen, and the other involving gain of electrons is reduced. That is, oxidation and reduction concurrently occur. The OH radical refers to an unstable ion of hydrogen (H⁺) and oxygen (O⁻), and these electrons oxidize various types of pollutants by reactions with the pollutants, and do sterilization and deodorization activities to turn the pollutants into safe water and air.

Additionally, oxidation reactions in bacteria peroxidize lipids of cell membranes by reactions between substances that constitute cell membranes or cell walls of the bacteria and OH radicals. The peroxidized cell membranes become immobile and material transport in and out the cell membranes are impaired, the function of the cell membranes does not work properly, and eventually the bacteria are killed.

Additionally, the present disclosure provides a system for reducing harmful substance in sewage and waste water for ecotoxicity removal, including the above-described apparatus for reducing harmful substance in sewage and waste water.

(Experimental Example) Sterilizing Power Evaluation Experiment

FIGS. 1 and 3 are cross-sectional views showing the structure of an apparatus according to an embodiment of the present disclosure. The main electron generation device 21a generates a plasma by a pulsed glow discharge method, producing electrons and produces radicals by inelastic collision reactions with neutral gas in the air, and after the electrons and radicals are injected into sewage and waste water and activated by activation of the wave generation devices 24, 25, the activated electrons and radicals are aerated by the activated electron aeration device 23 and the activated electrons and radicals and the sewage and waste water are allowed to move between the multiple plates 26, 27, 28, 29, 30, 31 spaced apart from each other to treat the sewage and waste water, and then the sterilizing capability of the treated sewage and waste water is evaluated.

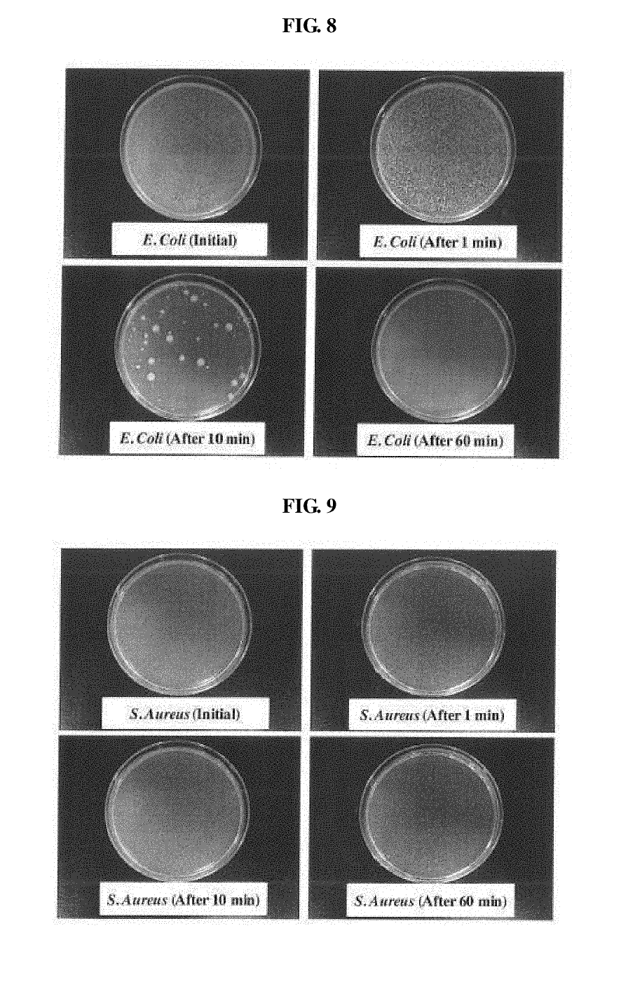

The following Table 1 and FIGS. 8 and 9 show the sterilizing power evaluation results of the apparatus for reducing harmful substance in sewage and waste water according to an embodiment of the present disclosure.

TABLE 1

| Classification | Initial | 1 min | 10 min | 60 min | Note |
|---|---|---|---|---|---|
| E. coli | 2.9 × 10⁵ | 2.4 × 10⁵ | 60 | <10 | Negative bacteria |
| | | (17.2%) | (99.9%) | (99.9% or more) | (Total coliforms) |
| S. aureus | 1.3 × 10⁵ | 1.4 × 10⁵ | 40 | <10 | Positive bacteria |
| | | (—) | (99.9%) | (99.9% or more) | (General bacteria) |
| S. flexneri | 4.4 × 10⁵ | 3.1 × 10⁵ | 2.9 × 10⁵ | <10 | |
| | | (29.6%) | (34.1%) | (99.9% or more) | |

Unit: CFU/mL

The above results show sterilization of E. coli of 17.2% in 1 minute, 99.9% in 10 minutes and 99.9% or more in 60 minutes. Sterilization of S. aureus is not observed for 1 minute, but sterilization of 99.9% in 10 minutes and 99.9% or more in 60 minutes is observed. Additionally, sterilization of S. flexneri of 29.6% in 1 minute, 34.1% in 10 minutes and 99.9% or more in 60 minutes is observed, and accordingly, it can be seen that the apparatus for reducing harmful substance in sewage and waste water according to the present disclosure has outstanding pollutant sterilizing and disinfecting power.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. An apparatus for reducing harmful substance in sewage and waste water for ecotoxicity removal, comprising:
a main decomposition unit in which sewage and waste water is treated, the main decomposition unit comprising:
a decomposition tank;
a main electron generation device provided outside of the decomposition tank to generate electron,
a main electron injection line which moves the electron from the main electron generation device into the decomposition tank;
a wave generation device provided in the decomposition tank to activate the electron generated from the main electron generation device by applying an electric field to the electron; and
multiple plates provided on an inner wall of the decomposition tank and the main electron injection line, spaced apart from each other,
wherein the main electron generation device comprising:
a discharge pin module provided with a support plate;
multiple discharge pins coupled to the support plate;
an elastic connection element electrically connecting a group of discharge pins including at least two adjacent discharge pins of the multiple discharge pins and coupled to the support plate;
a discharge plate placed facing the multiple discharge pins;
a support structure provided with a coupling plate positioned on an opposite side to the discharge plate with the support plate interposed between, the discharge pin module and the discharge plate being detachably coupled to the coupling plate; and
a circuit module provided with a main board positioned apart from the coupling plate on an opposite side to the discharge pin module with the coupling plate interposed between, and multiple distributed processing boards connected to the main board to enable individual application of high voltage, high frequency pulsed power to the group of discharge pins,
wherein the coupling plate has multiple connection protrusions each electrically connected to the multiple distributed processing boards, and an end of the elastic connection element comes into contact with the connection protrusion.

2. The apparatus for reducing harmful substance in sewage and waste water for ecotoxicity removal of claim 1, wherein the sewage and waste water is supplied from an oxidation tank installed at a front end of the main decomposition unit.

3. The apparatus for reducing harmful substance in sewage and waste water of claim 1, further comprising:
an activated electron aeration device on a lower surface of the decomposition tank,
wherein the activated electron and radical generated from the main electron generation device is aerated by the activated electron aeration device to decompose the sewage and waste water in the decomposition tank.

4. The apparatus for reducing harmful substance in sewage and waste water for ecotoxicity removal of claim 2, wherein the activated electron and radical generated from the main electron generation device is activated by the wave generation device while passing by the multiple plates obliquely extending spaced apart from each other from the lower surface of the decomposition tank, and the sewage and waste water is decomposed and discharged to the oxidation tank.

5. A system for reducing harmful substance in sewage and waste water for ecotoxicity removal comprising the apparatus for reducing harmful substance in sewage and waste water defined in claim 1.

6. An apparatus for reducing harmful substance in sewage and waste water for ecotoxicity removal, comprising:
a main decomposition unit in which sewage and waste water is treated, the main decomposition unit comprising:
a decomposition tank;
a main electron generation device provided outside of the decomposition tank to generate electron,
a main electron injection line which moves the electron from the main electron generation device into the decomposition tank;
a wave generation device provided in the decomposition tank to activate the electron generated from the main electron generation device by applying an electric field to the electron; and
multiple plates provided on an inner wall of the decomposition tank and the main electron injection line, spaced apart from each other;
an oxidation tank installed at a front end of the main decomposition unit; and
an activated electron aeration device on a lower surface of the decomposition tank,
wherein the activated electron and radical generated from the main electron generation device is aerated by the activated electron aeration device to decompose the sewage and waste water in the decomposition tank.

7. The apparatus for reducing harmful substance in sewage and waste water for ecotoxicity removal of claim 6, wherein the activated electron and radical generated from the main electron generation device is activated by the wave generation device while passing by the multiple plates obliquely extending spaced apart from each other from the lower surface of the decomposition tank, and the sewage and waste water is decomposed and discharged to the oxidation tank.
